(19) United States
(12) Patent Application Publication
(10) Pub. No.: US 2022/0407079 A1
(43) Pub. Date: Dec. 22, 2022

(54) BIPOLAR CURRENT COLLECTOR AND METHOD OF MAKING THE SAME

(71) Applicant: GM GLOBAL TECHNOLOGY OPERATIONS LLC, Detroit, MI (US)

(72) Inventors: Qi LU, Shanghai (CN); Zhe LI, Shanghai (CN)

(73) Assignee: GM GLOBAL TECHNOLOGY OPERATIONS LLC, Detroit, MI (US)

(21) Appl. No.: 17/698,865

(22) Filed: Mar. 18, 2022

(30) Foreign Application Priority Data
Jun. 16, 2021 (CN) 202110665785.4

(51) Int. Cl. H01M 4/66; H01M 4/04

(52) U.S. Cl. CPC H01M 4/662; H01M 4/0435; H01M 4/0419; H01M 4/0471; H01M 2004/029

(57) ABSTRACT

The present disclosure provides a method for forming a bipolar current collector. The method may include heating a first current collector material having a first melting point to form a molten metal or metal alloy and disposing the molten metal or metal alloy on one or more surfaces of a second current collector material having a second melting point greater than the first melting point to form the bipolar current collector. The molten metal or metal alloy may be disposed on the one or more surfaces of the second current collector material using a twin-roll casting method or a spraying method. The bipolar current collector may include a first current collector including the first current collector material, a second current collector including the second current collector material, and an inter-diffusion layer that connects the first current collector and the second current collector.

### CROSS-REFERENCE TO RELATED APPLICATIONS

This application claims the benefit of Chinese Patent Application No. 202110665785.4, filed Jun. 16, 2021. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which include a solid-state electrolyte layer disposed between solid-state electrodes, the solid-state electrolyte physically separates the solid-state electrodes so that a distinct separator is not required.

Solid-state batteries have advantages over batteries that include a separator and a liquid electrolyte. These advantages can include a lower self-discharge, simpler thermal management, a reduced need for packaging, and the ability to operate within a wider temperature window. For example, solid-state electrolytes are generally non-volatile and non-flammable allowing cells to be cycled under harsher conditions without experiencing diminished potential or thermal runaway, which can potentially occur with the use of liquid electrolytes. Solid-state electrolytes can also enable the implementation of a bipolar design while reducing or eliminating electrolyte leakage. The bipolar design can increase energy density and lower battery system cost by eliminating the need for passive components and parts required for packaging, as well as external electrical connections. However, bipolar solid-state batteries generally experience comparatively low power capabilities. For example, such low power capabilities may be a result of interfacial resistance caused by limited contact between the two halves of a bipolar or clad-foil current collector. Accordingly, it would be desirable to develop high-performance solid-state battery designs, materials, and methods that improve power capabilities.

### SUMMARY

This section provides a general summary of the disclosure, and is not a comprehensive disclosure of its full scope or all of its features.

The present disclosure relates to solid-state batteries (SSBs), for example bipolar solid-state batteries, that include bipolar current collectors having improved inter-diffusion layers, and methods of forming and using such solid-state batteries having bipolar current collectors.

In various aspects, the present disclosure provides a method for forming a bipolar current collector. The method may include heating a first current collector material having a first melting point to form a molten metal or metal alloy and disposing the molten metal or metal alloy on one or more surfaces of a second current collector material having a second melting point greater than the first melting point to form the bipolar current collector. The bipolar current collector may include a first current collector including the first current collector material, a second current collector including the second current collector material, and an inter-diffusion layer that connects the first current collector and the second current collector.

In one aspect, disposing the molten metal or metal alloy on the one or more surfaces of the second current collector material may include a twin-roll casting process. The twin-roll casting process may include introducing the molten metal or metal alloy and the second current collector material together into a void between a first roller and a second roller and passing the molten metal or metal alloy and the second current collector material between the rollers such that the molten metal or metal alloy binds to the second current collector material to form the bipolar current collector.

In one aspect, disposing the molten metal or metal alloy on the one or more surfaces of the second current collector material may include a twin-roll casting process. The twin-roll casting process may include introducing the molten metal or metal alloy and the second current collector material together into a void between a first roller and a second roller and passing the molten metal or metal alloy and the second current collector material between the rollers such that the molten metal or metal alloy binds to the second current collector material to form a bipolar sheet material having a first thickness. The method may further include cold-rolling the bipolar sheet material to form the bipolar current collector. The bipolar current collector may have a second thickness. The second thickness may be less than the first thickness of the bipolar sheet material.

In one aspect, disposing the molten metal or metal alloy on the one or more surfaces of the second current collector material may include a spraying process. The spraying process may include moving the second current collector material relative to a sprayer and spraying the molten metal or metal alloy onto the one or more surfaces of the second current collector material as it moves relative to the sprayer to form the bipolar current collector.

In one aspect, the sprayer may be a thermal arc sprayer.

In one aspect, the sprayer may be a plasma sprayer.

In one aspect, disposing the molten metal or metal alloy on the one or more surfaces of the second current collector material may include a spraying process. The spraying process may include moving the second current collector material relative to a sprayer and spraying the molten metal or metal alloy onto the one or more surfaces of the second current collector material as it moves relative to the sprayer to form a bipolar sheet material having a first thickness. The method may further include cold-rolling the bipolar sheet material to form the bipolar current collector. The bipolar current collector may have a second thickness. The second thickness may be less than the first thickness of the bipolar sheet material.

In one aspect, the sprayer may be one of a thermal arc sprayer and a plasma sprayer.

In one aspect, the first current collector may form greater than or equal to about 5% to less than or equal to about 90% of a total thickness of the bipolar current collector; the second current collector may form greater than or equal to about 10% to less than or equal to about 95% of the total thickness of the bipolar current collector; and the inter-diffusion layer may form greater than or equal to about 0.01% to less than or equal to about 30% of the total thickness of the bipolar current collector.

In one aspect, the first current collector may have a thickness greater than or equal to about 0.15 μm to less than or equal to about 27 μm; the second current collector may have a thickness greater than or equal to about 0.3 μm to less than or equal to about 28.5 μm; and the inter-diffusion layer may have a thickness greater than or equal to about 0.01 μm to less than or equal to about 9 μm.

In one aspect, the bipolar current collector may have a total thickness greater than or equal to about 3 μm to less than or equal to about 30 μm.

In one aspect, the first current collector material may be selected from the group consisting of: aluminum, aluminum alloy, magnesium, magnesium alloy, and combinations thereof.

In one aspect, the second current collector material may be selected from the group consisting of: copper, copper alloy, nickel, nickel alloy, stainless steel, titanium, titanium alloy, and combinations thereof.

In various aspects, the present disclosure provides a method for forming a bipolar current collector. The method may include heating a first current collector material to form a molten metal or metal alloy. The first current collector material may have a first melting point. The first current collector material may be selected from the group consisting of: aluminum, aluminum alloy, magnesium, magnesium alloy, and combinations thereof. The method may further include disposing the molten metal or metal alloy on one or more surfaces of a second current collector material to form a bipolar sheet material. The second current collector material may have a second melting point greater than the first melting point. The second current collector material may be selected from the group consisting of: copper, copper alloy, nickel, nickel alloy, stainless steel, titanium, titanium alloy, and combinations thereof. The bipolar sheet material may have a first thickness. The method may further include cold rolling the bipolar sheet material to form the bipolar current collector. The bipolar current collector may have a second thickness less than the first thickness. The bipolar current collector may include a first current collector including the first current collector material, a second current collector including the second current collector material, and an inter-diffusion layer that connects the first current collector and the second current collector.

In one aspect, disposing the molten metal or metal alloy on the one or more surfaces of the second current collector material may include a twin-roll casting process. The twin-roll casting process may include introducing the molten metal or metal alloy and the second current collector material together into a void between a first roller and a second roller and passing the molten metal or metal alloy and the second current collector material between the rollers such that the molten metal or metal alloy binds to the second current collector material to form the bipolar sheet material.

In one aspect, disposing the molten metal or metal alloy on the one or more surfaces of the second current collector material may include a spraying process. The spraying process may include moving the second current collector material relative to a sprayer and spraying the molten metal or metal alloy onto the one or more surfaces of the second current collector material as it moves relative to the sprayer to form the bipolar sheet material.

In one aspect, the sprayer may be one of a thermal arc sprayer and a plasma sprayer.

In one aspect, the first current collector may form greater than or equal to about 5% to less than or equal to about 90% of a total thickness of the bipolar current collector.

In one aspect, the second current collector may form greater than or equal to about 10% to less than or equal to about 95% of the total thickness of the bipolar current collector.

In one aspect, the inter-diffusion layer may form greater than or equal to about 0.01% to less than or equal to about 30% of the total thickness of the bipolar current collector.

In one aspect, the first current collector may have a thickness greater than or equal to about 0.15 μm to less than or equal to about 27 μm.

In one aspect, a second current collector may have a thickness greater than or equal to about 0.3 μm to less than or equal to about 28.5 μm.

In one aspect, an inter-diffusion may have a thickness greater than or equal to about 0.01 μm to less than or equal to about 9 μm.

In various aspects, the present disclosure provides a method for forming a solid-state battery that cycles lithium ions. The method may include incorporating one or more bipolar collectors into a battery stack that defines the solid-state battery. Each of the one or more bipolar collectors may include a first current collector including a first current collector material having a first melting point; a second current collector including a second current collector material having a second melting point that is greater than the first melting point; and an inter-diffusion layer having a thickness greater than or equal to about 0.01 μm to less than or equal to about 9 μm that connects a surface of the first current collector and a surface of the second current collector, where the surface of the first current collector and the surface of the second current collector are parallel.

In one aspect, the first current collector material may be selected from the group consisting of: aluminum, aluminum alloy, magnesium, magnesium alloy, and combinations thereof.

In one aspect, the second current collector material may be selected from the group consisting of: copper, copper alloy, nickel, nickel alloy, stainless steel, titanium, titanium alloy, and combinations thereof.

In one aspect, the first current collector may form greater than or equal to about 5% to less than or equal to about 90% of a total thickness of the bipolar current collector; the second current collector may form greater than or equal to about 10% to less than or equal to about 95% of the total thickness of the bipolar current collector; and the inter-diffusion layer may form greater than or equal to about 0.01% to less than or equal to about 30% of the total thickness of the bipolar current collector.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state, bipolar battery having a bipolar current collector in accordance with various aspects of the present disclosure;

FIG. 2 is an illustration of the example bipolar current collector in accordance with various aspects of the present disclosure;

FIG. 3 is an illustration of an example method for forming a bipolar current collector, like the example bipolar current collector illustrated in FIG. 2, in accordance with various aspects of the present disclosure;

FIG. 4 is an illustration of an example method for disposing a molten metal or metal alloy on a foil to form a bipolar current collector, like the example bipolar current collector illustrated in FIG. 2, in accordance with various aspects of the present disclosure; and

FIG. 5 is an illustration of another example method for disposing a molten metal or metal alloy on a foil to form a bipolar current collector, like the example bipolar current collector illustrated in FIG. 2, in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs), for example only, bipolar solid-state batteries, including bipolar current collectors having an improved inter-diffusion layer, and methods of forming and using such solid-state batteries.

Solid-state batteries may include at least one solid component, for example, at least one solid electrode, but may also include semi-solid or gel, liquid, or gas components, in certain variations. Solid-state batteries may have a bipolar stacking design comprising a plurality of bipolar electrodes where a first mixture of solid-state electroactive material particles (and optional solid-state electrolyte particles) is disposed on a first side of a bipolar current collector, and a second mixture of solid-state electroactive material particles (and optional solid-state electrolyte particles) is disposed on a second side of the bipolar current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance

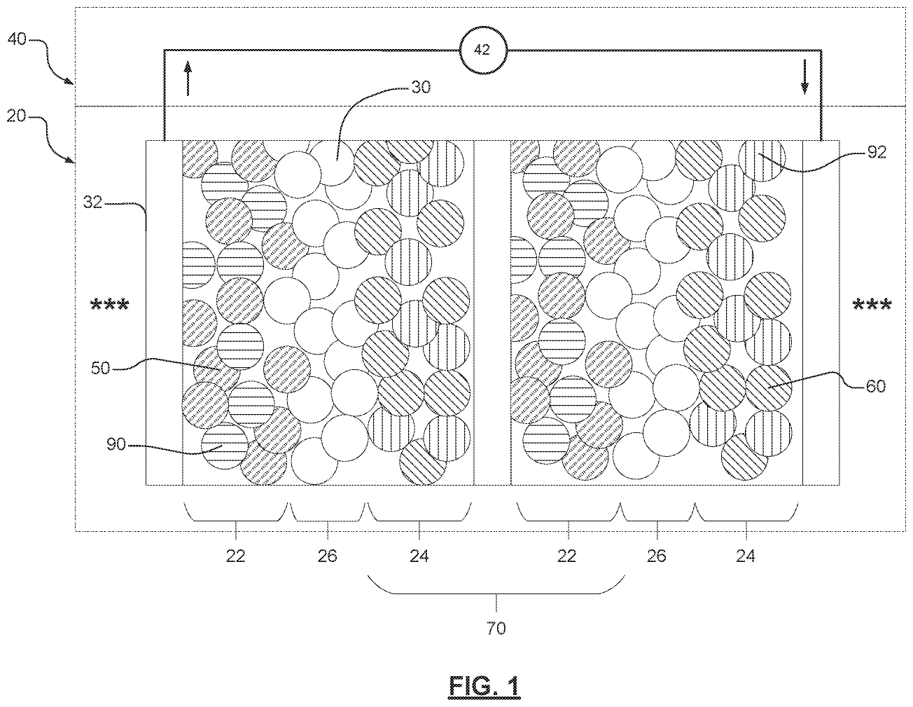

An exemplary and schematic illustration of a solid-state electrochemical cell (also referred to as the “solid-state battery” and/or “battery”) 20 that cycles lithium ions is shown in FIG. 1. The battery 20 includes one or more bipolar electrodes 70. Each bipolar electrode 70 includes a negative electrode (i.e., anode) 22, a positive electrode (i.e., cathode) 24, and a bipolar current collector 32 that physically separates the negative electrode 22 and the positive electrode 24. The battery 20 may thus include one or more negative electrodes 22, one or more positive electrodes 24, and one or more bipolar current collectors 32.

Although the illustrated examples include only one bipolar electrode, the skilled artisan will recognize that the current teachings apply to various other configurations, including those having two or more bipolar electrodes 70. The asterisks are meant to illustrate that the battery 20 may include additional electrodes (e.g., bipolar electrodes 70, negative electrodes 22, and/or positive electrodes 24), as would be appreciated by the skilled artisan. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around one or more of the bipolar electrodes 70 and/or the solid-state electrolyte 26 layer.

A solid-state electrolyte layer 26 is disposed between each consecutive bipolar electrode 70, such that the solid-state layer 26 is a separating layer that physically separates the negative electrode 22 of a first bipolar electrode 70 and a positive electrode 24 of a second bipolar electrode 70. The solid-state electrolyte layers 26 may be defined by a first plurality of solid-state electrolyte particles 30. A second plurality of solid-state electrolyte particles 90 may be mixed with negative solid-state electroactive particles 50 in the negative electrodes 22, and a third plurality of solid-state electrolyte particles 92 may be mixed with positive solid-state electroactive particles 60 in the positive electrodes 24, so as to form a continuous electrolyte network, which may be a continuous lithium-ion conduction network.

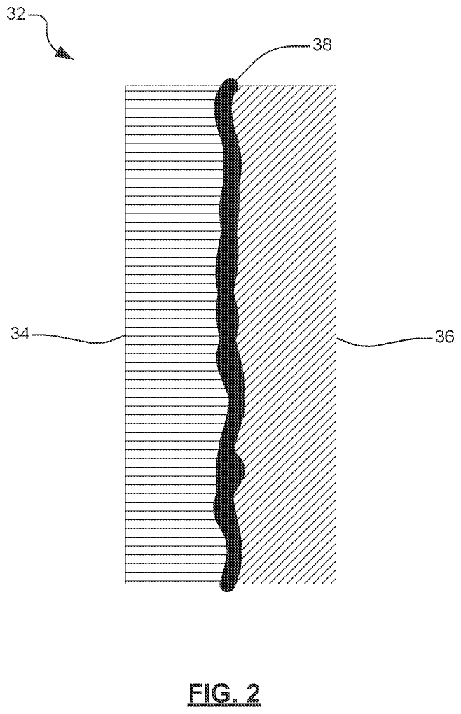

As illustrated in FIG. 2, the bipolar current collector 32 may include a first current collector 34 fused with a second current collector 36. The first current collector 34 may be a positive current collector that is positioned at or near the positive electrode 24. The second current collector 36 may be a negative current collector that is positioned at or near the negative electrode 22. The first current collector 34 may be formed from aluminum, aluminum alloy, magnesium, magnesium alloy, or any combination thereof. The second current collector 36 may be formed from copper, copper alloy, nickel, nickel alloy, stainless steel, titanium, titanium alloy, or any combination thereof.

The first current collector 34 may form greater than or equal to about 5% to less than or equal to about 90%, and in certain aspects, optionally greater than or equal to about 30% to less than or equal to about 60%, of a total thickness of the bipolar current collector. The second current collector 36 may form greater than or equal to about 10% to less than or equal to about 95%, and in certain aspects, optionally greater than or equal to about 20% to less than or equal to about 60%, of the total thickness of the bipolar current collector. An inter-diffusion layer 38 that fuses or connects the first current collector 34 and the second current collector 36 may form greater than or equal to about 0.01% to less than or equal to about 30%, and in certain aspects, optionally greater than or equal to about 0.1% to less than or equal to about 5%, of a total thickness of the bipolar current collector.

For example, the total thickness of the bipolar current collector 32 may be greater than or equal to about 3 μm to less than or equal to about 30 μm. The first current collector 34 may have a thickness greater than or equal to about 0.15 μm to less than or equal to about 27 μm, and in certain aspects, optionally greater than or equal to about 0.9 μm to less than or equal to about 10 μm. The second current collector 36 may have a thickness greater than or equal to about 0.3 μm to less than or equal to about 28.5 μm, and in certain aspects, optionally greater than or equal to about 0.6 μm to less than or equal to about 18 μm. The inter-diffusion layer 38 may have a thickness greater than or equal to about 0.01 μm to less than or equal to about 9 μm, and in certain aspects, optionally greater than or equal to about 0.1 μm to less than or equal to about 5 μm.

With renewed reference to FIG. 1, the battery 20 can generate an electric current (indicated by arrows in FIG. 1) during discharge by way of reversible electrochemical reactions that occur when the external circuit 40 is closed (to connect one of the one or more negative electrodes 22 and one of the one or more positive electrodes 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrodes 22, are concurrently transferred through the electrolyte layer 26 towards the positive electrodes 24. The electrons flow through the external circuit 40 and the lithium ions migrate across the electrolyte layer 26 to the positive electrodes 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the electrolyte layers 26 provide electrical separation—preventing physical contact—between a negative electrode 22 of a first bipolar electrode 70 and the positive electrode 24 of a second bipolar electrode 70 and/or a negative electrode 22 of the second bipolar electrode 70 and the positive electrode 24 of a third bipolar electrode 70, and the like. The solid-state electrolyte layers 26 also provide minimal resistance paths for internal passage of ions. In various aspects, each solid-state electrolyte layers 26 may be defined by a first plurality of solid-state electrolyte particles 30. For example, each solid-state electrolyte layer 26 may be in the form of a layer or a composite that comprises the first plurality of solid-state electrolyte particles 30. The solid-state electrolyte particles 30 may have an average particle diameter greater than or equal to about 0.02 μm to less than or equal to about 20 μm, optionally greater than or equal to about 0.1 μm to less than or equal to about 10 μm, and in certain aspects, optionally greater than or equal to about 0.1 μm to less than or equal to about 1 μm. The solid-state electrolyte layer 26 may be in the form of a layer having a thickness greater than or equal to about 5 μm to less than or equal to about 200 μm, optionally greater than or equal to about 10 μm to less than or equal to about 100 μm, optionally about 40 μm, and in certain aspects, optionally about 30 μm.

The solid-state electrolyte particles 30 may comprise one or more sulfide-based particles, oxide-based particles, metal-doped or aliovalent-substituted oxide particles, nitride-based particles, hydride-based particles, halide-based particles, and borate-based particles.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ(PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), and combinations thereof.

In certain variations, the sulfide-based particles may include, for example only, a pseudobinary sulfide, a pseudoternary sulfide, and/or a pseudoquaternary sulfide. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI.0.6Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

In certain variations, the nitride-based particles may include, for example only, Li₃N, Li₇PN₄, LiSi₂N₃, and combinations thereof; the hydride-based particles may include, for example only, LiBH₄, LiBH₄—LiX (where x=Cl, Br, or I), LiNH₂, Li₂NH, LiBH₄—LiNH₂, Li₃AlH₆, and combinations thereof; the halide-based particles may include, for example only, LiI, Li₃InCl₆, Li₂CdC₁₄, Li₂MgCl₄, LiCdI₄, Li₂ZnI₄, Li₃OCl, Li₃YCl₆, Li₃YBr₆, and combinations thereof; and the borate-based particles may include, for example only, Li₂B₄O₇, Li₂O—B₂O₃—P₂O₅, and combinations thereof.

In various aspects, the first plurality of solid-state electrolyte particles 30 may include one or more electrolyte materials selected from the group consisting of: Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1−x)P₂S₅-xLi₂S (where 0.5≤x≤0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), LiMM′(PO₄)₃ (where M and M′ are independently selected from Al, Ge, Ti, Sn, Hf, Zr, and La), Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), LiI—Li₄SnS₄, Li₄SnS₄, Li₃N, Li₇PN₄, LiSi₂N₃, LiBH₄, LiBH₄—LiX (where x=Cl, Br, or I), LiNH₂, Li₂NH, LiBH₄—LiNH₂, Li₃AlH₆, LiI, Li₃InCl₆, Li₂CdC₁₄, Li₂MgCl₄, LiCdI₄, Li₂ZnI₄, Li₃OCl, Li₂B₄O₇, Li₂O—B₂O₃—P₂O₅, and combinations thereof.

In certain variations, the first plurality of solid-state electrolyte particles 30 may include one or more electrolyte materials selected from the group consisting of: Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1−x)P₂S₅-xLi₂S (where 0.5≤x≤0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, and combinations thereof.

Although not illustrated, the skilled artisan will recognize that in certain instances, one or more binder particles may be mixed with the solid-state electrolyte particles 30. For example, in certain aspects each solid-state electrolyte layer 26 may include greater than or equal to about 0 wt. % to less than or equal to about 10 wt. %, and in certain aspects, optionally greater than or equal to about 0.5 wt. % to less than or equal to about 10 wt. %, of the one or more binders. The one or more binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

In certain instances, the solid-state electrolyte particles 30 (and the optionally one or more binder particles) may be wetted by a small amount of liquid electrolyte, for example, to improve ionic conduction between the solid-state electrolyte particles 30. The solid-state electrolyte particles 30 may be wetted by greater than or equal to about 0 wt. % to less than or equal to about 40 wt. %, optionally greater than or equal to about 0.1 wt. % to less than or equal to about 40 wt. %, and in certain aspects, optionally greater than or equal to about 5 wt. % to less or equal to about 10 wt. %, of a liquid electrolyte, based on the weight of the solid-state electrolyte particles 30. In certain variations, Li₇P₃S₁₁ may be wetted by an ionic liquid electrolyte including LiTFSI-triethylene glycol dimethyl ether.

Each negative electrode 22 may be formed from a lithium host material that is capable of functioning as a negative terminal of a lithium-ion battery. For example, in certain variations, each negative electrode 22 may be defined by a plurality of the negative solid-state electroactive particles 50. In certain instances, as illustrated, each negative electrode 22 is a composite comprising a mixture of the negative solid-state electroactive particles 50 and the second plurality of solid-state electrolyte particles 90. For example, each negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50 and greater than or equal to about 0 wt. % to less than or equal to about 50 wt. %, and in certain aspects, optionally greater than or equal to about 5 wt. % to less than or equal to about 20 wt. %, of the second plurality of solid-state electrolyte particles 90.

The second plurality of solid-state electrolyte particles 90 may be the same as or different from the first plurality of solid-state electrolyte particles 30. In certain variations, the negative solid-state electroactive particles 50 may be lithium-based including, for example, a lithium alloy and/or a lithium metal. In other variations, the negative solid-state electroactive particles 50 may be silicon-based comprising, for example, silicon, a silicon alloy and/or silicon-graphite mixture. In still other variations, the negative electrodes 22 may be a carbonaceous anode and the negative solid-state electroactive particles 50 may comprise one or more negative electroactive materials, such as graphite, graphene, hard carbon, soft carbon, and carbon nanotubes (CNTs). In still further variations, the negative electrodes 22 may comprise one or more negative electroactive materials, such as lithium titanium oxide (Li₄Ti₅O₁₂); one or more metal oxides, such as TiO₂ and/or V₂O₅; and metal sulfides, such as FeS. Thus, the negative solid-state electroactive particles 50 may be selected from the group including, for example only, lithium, graphite, graphene, hard carbon, soft carbon, carbon nanotubes, silicon, silicon-containing alloys, tin-containing alloys, and combinations thereof.

In certain variations, the negative electrodes 22 may further include one or more conductive additives and/or binder materials. For example, the negative solid-state electroactive particles 50 and the second plurality of solid-state electrolyte particles 90 may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 and the second plurality of solid-state electrolyte particles 90 may be optionally intermingled with binders, such as polyvinylidene difluoride (PVDF), poly(vinylidene fluoride-co-hexafluoropropylene (PVdF-HFP), polytetrafluoroethylene (PTFE), carboxymethyl cellulose (CMC), styrene ethylene butylene styrene copolymer (SEBS), ethylene propylene diene monomer (EPDM) rubber, nitrile butadiene rubber (NBR), styrene-butadiene rubber (SBR), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as, graphene oxide), carbon black (such as, Super P), and the like. Examples of a conductive polymer may include polyaniline, polythiophene, polyacetylene, polypyrrole, and the like. In certain aspects, mixtures of the conductive additives and/or binder materials may be used.

The negative electrodes 22 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

Each positive electrode 24 may be formed from a lithium-based or electroactive material that can undergo lithium intercalation and deintercalation while functioning as the positive terminal of the battery 20. For example, in certain variations, each positive electrode 24 may be defined by a plurality of the positive solid-state electroactive particles 60. In certain instances, as illustrated, each positive electrode 24 is a composite comprising a mixture of the positive solid-state electroactive particles 60 and the third plurality of solid-state electrolyte particles 92. For example, each positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60 and greater than or equal to about 0 wt. % to less than or equal to about 50 wt. %, and in certain aspects, optionally greater than or equal to about 5 wt. % to less than or equal to about 20 wt. %, of the third plurality of solid-state electrolyte particles 92.

The third plurality of solid-state electrolyte particles 92 may be the same as or different from the first and/or second pluralities of solid-state electrolyte particles 30, 90. In certain variations, the positive electrodes 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNi_{0.5}Mn_{1.5}O₄. The polyanion cathode may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO4 for lithium-ion batteries. In other instances, the positive electrode 24 may include one or more low voltage materials, such as lithium metal oxide/sulfide (like LiTiS₂) and/or lithium sulfide.

In various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, LiTiS₂, and combinations thereof. In certain aspects, the positive solid-state electroactive particles 60 may be coated (for example, by LiNbO₃, Al₂O₃, Li₂ZrO₃, and/or Li₃PO₄) and/or the positive electroactive material may be doped (for example, by aluminum and/or magnesium).

In certain variations, the positive electrodes 24 may further include one or more conductive additives and/or binder materials. For example, the positive solid-state electroactive particles 60 and the third plurality of solid-state electrolyte particles 92 may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 and the third plurality of solid-state electrolyte particles 92 may be optionally intermingled with binders, like polyvinylidene difluoride (PVDF), poly(vinylidene fluoride-co-hexafluoropropylene (PVdF-HFP), polytetrafluoroethylene (PTFE), sodium carboxymethyl cellulose (CMC), styrene ethylene butylene styrene copolymer (SEBS), ethylene propylene diene monomer (EPDM) rubber, nitrile butadiene rubber (NBR), styrene-butadiene rubber (SBR), and/or lithium polyacrylate (LiPAA) binders. Electrically conductive materials may include, for example, carbon-based materials. Carbon-based materials may include, for example, particles of graphite, acetylene black (such as KETCHEN™ black or DENKA™ black), carbon fibers and nanotubes, graphene (such as graphene oxide), carbon black (such as Super P), and the like. In certain aspects, mixtures of the conductive additives and/or binder materials may be used.

The positive electrodes 24 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

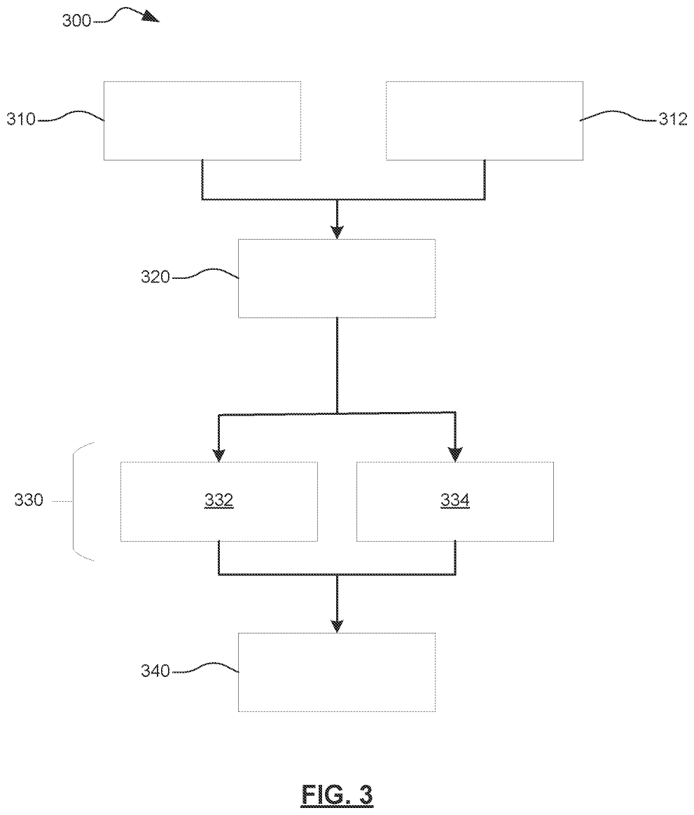

In various aspects, the present disclosure provides methods for preparing a bipolar current collector, like the bipolar current collector 32 illustrated in FIGS. 1 and 2. The method may be a continuous process. For example, FIG. 3 illustrates one example method 300 for preparing a bipolar current collector. The method 300 includes heating 320 a first current collector material to form a molten metal or metal alloy 324. The first current collector material has a first melting point and heating 320 the first current collector material includes heating the first current collector material to a temperature at or greater than the first melting point. For example, the first current collector material may include aluminum, aluminum alloy, magnesium, magnesium alloy, or any combination thereof. In certain aspects, the method 300 may include obtaining 310 the first current collector material. Obtaining 310 the first current collector material may include preparing the first current collector material.

The method 300 includes disposing 330 the molten metal or metal alloy 324 on one or more surfaces of a second current collector material 314 to form a bipolar sheet material. In certain variations, the second current collector material 314 may be in the form of a strip having an elongate axis or length greater than a width. The second current collector material 314 may be formed from copper, copper alloy, nickel, nickel alloy, stainless steel, titanium, titanium alloy, or any combination thereof. The second current collector material 314 has a second melting point greater than the first melting point of the first current collector material. For example, in certain variations, the second melting point is greater than or equal to about 50° C. greater than the first melting point

In various aspects, the method 300 may include obtaining 312 the second current collector material 314. Obtaining 312 the second current collector material 314 may include preparing the second current collector material 314. Though obtaining 312 is illustrated as occurring concurrently with obtaining 310, the skilled artisan will recognize that obtaining 312 may occur earlier or later in the process, including for example only, prior to the disposing 330 of the molten metal or metal alloy 324 onto the second current collector material 314.

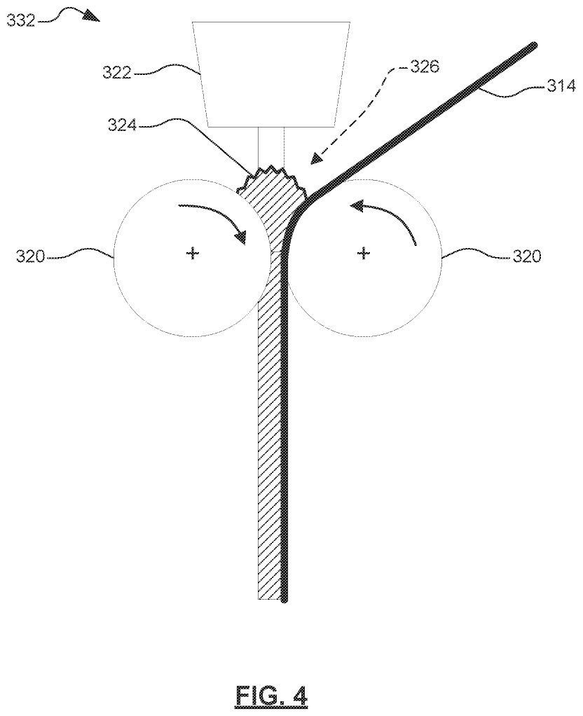

In various aspects, the molten metal or metal alloy 324 may be disposed 330 on the one or more surfaces of the second current collector material 314 using a twin-roll casting process 332. As illustrated in FIG. 4, the twin-roll casting process 332 may include introducing the molten metal or metal alloy 324 and second current collector material 314 into a void 326 between a first roller 328A and a second roller 328B. The molten metal or metal alloy 324 may be introduced from a reservoir or melt supply 322. As the molten metal or metal alloy 324 and second current collector material 314 are passed between the rollers 328A, 328B the molten metal or metal alloy 324 may be solidified and bonded to the second current collector material 314.

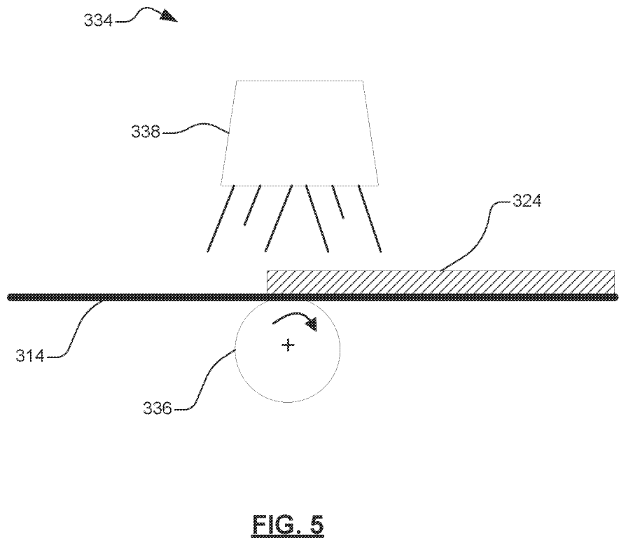

In various other aspects, the molten metal or metal alloy 324 may be disposed 330 on the one or more surfaces of the second current collector material 314 using a spraying process 334. As illustrated in FIG. 5, the second current collector material 314 may be moved relative to a sprayer 338 using a conveyor system 336 and the spraying process 334 may include spraying the molten metal or metal alloy 324 onto a first surface of the second current collector material 314. In certain variations, the sprayer 338 may be a thermal arc sprayer. In other variations, the sprayer 338 may be a plasma sprayer.

With renewed reference to FIG. 3, in each instance, the method 300 may further include cold rolling 340 the second current collector material 314 coated with the first current collector material 324 to form the bipolar current collector. The second current collector material 314 coated with the first current collector material 324 may be cold rolled 340 where the temperature of the second current collector material 314 coated with the first current collector material 324 is less than the first melting point. Cold rolling 340 includes moving the second current collector material 314 coated with the first current collector material 324 through a one or more pair of rollers to compress the second current collector material 314 coated with the first current collector material 324 to form the bipolar current collector. For example, the second current collector material 314 coated with the first current collector material 324 may have a total thickness greater than or equal to about 10 μm to less than or equal to about 10,000 μm, and in certain aspects, optionally greater than or equal to about 100 μm to less than or equal to about 5,000 μm. After cold rolling 340, a total thickness of the bipolar current collector may be greater than or equal to about 3 μm to less than or equal to about 30 μm. The bipolar current collector has a first current collector and a second current collector.

The first current collector material coating defines the first current collector. The first current collector may have a thickness greater than or equal to about 0.15 μm to less than or equal to about 27 μm, and in certain aspects, optionally greater than or equal to about 0.9 μm to less than or equal to about 10 μm. The second current collector material defines the second current collector. The second current collector material may have a thickness greater than or equal to about 0.3 μm to less than or equal to about 28.5 μm, and in certain aspects, optionally greater than or equal to about 0.6 μm to less than or equal to about 18 μm. An inter-diffusion layer that fuses or connects the first current collector and the second current collector has a thickness greater than or equal to about 0.01 μm to less than or equal to about 9 μm, and in certain aspects, optionally greater than or equal to about 0.1 μm to less than or equal to about 5 μm.

The bipolar current collector may be introduced into a cell including negative electrodes and positive electrodes, like battery 20 illustrated in FIG. 1.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for forming a bipolar current collector, the method comprising:
heating a first current collector material to form a molten metal or metal alloy, wherein the first current collector material has a first melting point; and
disposing the molten metal or metal alloy on one or more surfaces of a second current collector material having a second melting point greater than the first melting point to form the bipolar current collector, wherein the bipolar current collector comprises a first current collector comprising the first current collector material, a second current collector comprising the second current collector material, and an inter-diffusion layer that connects the first current collector and the second current collector.

2. The method of claim 1, wherein disposing the molten metal or metal alloy on the one or more surfaces of the second current collector material comprises a twin-roll casting process, the twin-roll casting process comprising introducing the molten metal or metal alloy and the second current collector material together into a void between a first roller and a second roller and passing the molten metal or metal alloy and the second current collector material between the rollers such that the molten metal or metal alloy binds to the second current collector material to form the bipolar current collector.

3. The method of claim 1, wherein disposing the molten metal or metal alloy on the one or more surfaces of the second current collector material comprises a twin-roll casting process, the twin-roll casting process comprising introducing the molten metal or metal alloy and the second current collector material together into a void between a first roller and a second roller and passing the molten metal or metal alloy and the second current collector material between the rollers such that the molten metal or metal alloy binds to the second current collector material to form a bipolar sheet material having a first thickness, and
wherein the method further comprises cold-rolling the bipolar sheet material to form the bipolar current collector, the bipolar current collector having a second thickness less than the first thickness.

4. The method of claim 1, wherein disposing the molten metal or metal alloy on the one or more surfaces of the second current collector material comprises a spraying process, the spraying process comprising moving the second current collector material relative to a sprayer and spraying the molten metal or metal alloy onto the one or more surfaces of the second current collector material as it moves relative to the sprayer to form the bipolar current collector.

5. The method of claim 4, wherein the sprayer is one of a thermal arc sprayer and a plasma sprayer.

6. The method of claim 1, wherein disposing the molten metal or metal alloy on the one or more surfaces of the second current collector material comprises a spraying process, the spraying process comprising moving the second current collector material relative to a sprayer and spraying the molten metal or metal alloy onto the one or more surfaces of the second current collector material as it moves relative to the sprayer to form a bipolar sheet material having a first thickness, and
wherein the method further comprises cold-rolling the bipolar sheet material to form the bipolar current collector, the bipolar current collector having a second thickness less than the first thickness.

7. The method of claim 6, wherein the sprayer is one of a thermal arc sprayer and a plasma sprayer.

8. The method of claim 1, wherein the first current collector forms greater than or equal to about 5% to less than or equal to about 90% of a total thickness of the bipolar current collector,
the second current collector forms greater than or equal to about 10% to less than or equal to about 95% of the total thickness of the bipolar current collector, and
the inter-diffusion layer forms greater than or equal to about 0.01% to less than or equal to about 30% of the total thickness of the bipolar current collector.

9. The method of claim 1, wherein the first current collector has a thickness greater than or equal to about 0.15 μm to less than or equal to about 27 μm,
the second current collector has a thickness greater than or equal to about 0.3 μm to less than or equal to about 28.5 μm, and
the inter-diffusion layer has a thickness greater than or equal to about 0.01 μm to less than or equal to about 9 μm.

10. The method of claim 1, wherein the bipolar current collector has a total thickness greater than or equal to about 3 μm to less than or equal to about 30 μm.

11. The method of claim 1, wherein the first current collector material is selected from the group consisting of: aluminum, aluminum alloy, magnesium, magnesium alloy, and combinations thereof, and
the second current collector material is selected from the group consisting of:
copper, copper alloy, nickel, nickel alloy, stainless steel, titanium, titanium alloy, and combinations thereof.

12. A method for forming a bipolar current collector, the method comprising:
heating a first current collector material to form a molten metal or metal alloy, wherein the first current collector material has a first melting point and is selected from the group consisting of: aluminum, aluminum alloy, magnesium, magnesium alloy, and combinations thereof;
disposing the molten metal or metal alloy on one or more surfaces of a second current collector material having a second melting point greater than the first melting point to form a bipolar sheet material having a first thickness, wherein the second current collector material is selected from the group consisting of: copper, copper alloy, nickel, nickel alloy, stainless steel, titanium, titanium alloy, and combinations thereof; and
cold rolling the bipolar sheet material to form the bipolar current collector, the bipolar current collector having a second thickness less than the first thickness and comprising a first current collector comprising the first current collector material, a second current collector comprising the second current collector material, and an inter-diffusion layer that connects the first current collector and the second current collector.

13. The method of claim 12, wherein disposing the molten metal or metal alloy on the one or more surfaces of the second current collector material comprises a twin-roll casting process, the twin-roll casting process comprising introducing the molten metal or metal alloy and the second current collector material together into a void between a first roller and a second roller and passing the molten metal or metal alloy and the second current collector material between the rollers such that the molten metal or metal alloy binds to the second current collector material to form the bipolar sheet material.

14. The method of claim 12, disposing the molten metal or metal alloy on the one or more surfaces of the second current collector material comprises a spraying process, the spraying process comprising moving the second current collector material relative to a sprayer and spraying the molten metal or metal alloy onto the one or more surfaces of the second current collector material as it moves relative to the sprayer to form the bipolar sheet material.

15. The method of claim 14, wherein the sprayer is one of a thermal arc sprayer and a plasma sprayer.

16. The method of claim 12, wherein the first current collector forms greater than or equal to about 5% to less than or equal to about 90% of a total thickness of the bipolar current collector,
the second current collector forms greater than or equal to about 10% to less than or equal to about 95% of the total thickness of the bipolar current collector, and
the inter-diffusion layer forms greater than or equal to about 0.01% to less than or equal to about 30% of the total thickness of the bipolar current collector.

17. The method of claim 12, wherein the first current collector has a thickness greater than or equal to about 0.15 μm to less than or equal to about 27 μm,
a second current collector has a thickness greater than or equal to about 0.3 μm to less than or equal to about 28.5 μm, and
an inter-diffusion has a thickness greater than or equal to about 0.01 μm to less than or equal to about 9 μm.

18. A method for forming a solid-state battery that cycles lithium ions, the method comprising:
incorporating one or more bipolar collectors into a battery stack that defines the solid-state battery, each of the one or more bipolar collectors comprises:
a first current collector comprising a first current collector material having a first melting point;
a second current collector comprising a second current collector material having a second melting point that is greater than the first melting point; and
an inter-diffusion layer having a thickness greater than or equal to about 0.01 μm to less than or equal to about 9 μm that connects a surface of the first current collector and a surface of the second current collector, wherein the surface of the first current collector and the surface of the second current collector are parallel.

19. The method of claim 18, wherein the first current collector material is selected from the group consisting of: aluminum, aluminum alloy, magnesium, magnesium alloy, and combinations thereof, and
the second current collector material is selected from the group consisting of:
copper, copper alloy, nickel, nickel alloy, stainless steel, titanium, titanium alloy, and combinations thereof.

20. The method of claim 18, wherein the first current collector forms greater than or equal to about 5% to less than or equal to about 90% of a total thickness of the bipolar current collector,
the second current collector forms greater than or equal to about 10% to less than or equal to about 95% of the total thickness of the bipolar current collector, and
the inter-diffusion layer forms greater than or equal to about 0.01% to less than or equal to about 30% of the total thickness of the bipolar current collector.
